(19) United States
(12) Patent Application Publication
(10) Pub. No.: US 2026/0359793 A1
(43) Pub. Date: Nov. 12, 2026

(54) INFORMATION PROCESSING DEVICE, COMPUTER-IMPLEMENTED INFORMATION PROCESSING METHOD, AND NON-TRANSITORY COMPUTER-READABLE MEDIUM

(71) Applicant: LegalOn Technologies, Inc., Tokyo (JP)

(72) Inventors: Ruka FUNAKI, Tokyo (JP); Sachiyo YASUDA, Tokyo (JP)

(21) Appl. No.: 19/720,768

(22) Filed: Jun. 25, 2026

Related U.S. Application Data
(63) Continuation of application No. PCT/JP2024/012650, filed on Mar. 28, 2024.

(30) Foreign Application Priority Data
Dec. 27, 2023 (JP) 2023-221488

(51) Int. Cl. G06Q 10/109

(52) U.S. Cl. CPC G06Q 10/109

(57) ABSTRACT

An information processing device according to embodiments may include at least one processor. The processor may register, in association with an issue including at least one agenda item, the at least one agenda item and at least one meeting held by at least one body of an organization to take an action on the at least one agenda item. The processor may output display information that displays, for each of the at least one agenda item, information based on a predetermined rule including information indicating a schedule or expectation of a future meeting to take an action on the agenda item.

### CROSS-REFERENCE TO RELATED APPLICATION

This application is a bypass continuation of International Application No. PCT/JP2024/012650, filed on Mar. 28, 2024, which claims priority to Japanese Patent Application No. 2023-221488, filed on Dec. 27, 2023, the entire contents of each of which are incorporated herein by reference.

### BACKGROUND

### Technical Field

Embodiments of the present disclosure relate to an information processing device, a computer-implemented information processing method, and a non-transitory computer-readable medium.

### Related Art

Conventionally, for the purpose of supporting the operation of an organization, there has been proposed a technique in which item names corresponding to each content with respect to precondition matters including a management philosophy and the like, and business-related matters including a business plan and the like, are arranged and displayed, when any one of the arranged item names is selected, an item input display that enables input of the content corresponding to the selection is changed and displayed in response to the selection, and when input to a specified item specified in advance or an operation of confirming the input among inputtable contents is received, the display is changed in an identifiable manner with respect to an item name corresponding to the input or the operation among the arranged item names. Related techniques are described, for example, in Japanese Patent Application Laid-Open Publication No. 2022-014405.

However, there is room for improvement in management of issues or information in the organization.

### SUMMARY

An information processing device according to embodiments includes at least one processor. The processor registers, in association with an issue including at least one agenda item, the at least one agenda item and at least one meeting held by at least one body of an organization to take an action on the at least one agenda item. The processor outputs display information that displays, for each of the at least one agenda item, information based on a predetermined rule including information indicating a schedule or expectation of a future meeting to take an action on the agenda item.

### BRIEF DESCRIPTION OF DRAWINGS

FIG. 1 is a schematic diagram for describing an outline of an information processing system according to an embodiment;

FIG. 2 is a block diagram illustrating an example of a hardware configuration of an information processing device according to the embodiment;

FIG. 3 is a block diagram illustrating an example of a functional configuration of the information processing device according to the embodiment;

FIG. 4 is a block diagram illustrating an example of a hardware configuration of a terminal device according to the embodiment;

FIG. 5 is a block diagram illustrating an example of a functional configuration of the terminal device according to the embodiment;

FIG. 6 is a flowchart illustrating an example of a procedure of corporate issue management regarding a corporate issue that requires decision-making by a decision-making body having a secretariat according to the embodiment;

FIG. 7 is a flowchart illustrating an example of a flow of corporate issue management processing according to the embodiment;

FIG. 8 is a figure illustrating an example of a display screen displayed on a display device of the terminal device in the corporate issue management processing according to the embodiment;

FIG. 9 is a figure illustrating an example of the display screen displayed on the display device of the terminal device in the corporate issue management processing according to the embodiment;

FIG. 10 is a figure illustrating an example of the display screen displayed on the display device of the terminal device in the corporate issue management processing according to the embodiment;

FIG. 11 is a figure illustrating an example of the display screen displayed on the display device of the terminal device in the corporate issue management processing according to the embodiment;

FIG. 12 is a figure illustrating an example of the display screen displayed on the display device of the terminal device in the corporate issue management processing according to the embodiment;

FIG. 13 is a figure illustrating an example of the display screen displayed on the display device of the terminal device in the corporate issue management processing according to the embodiment;

FIG. 14 is a figure illustrating an example of the display screen displayed on the display device of the terminal device in the corporate issue management processing according to the embodiment; and

FIG. 15 is a figure illustrating an example of the display screen displayed on the display device of the terminal device in the corporate issue management processing according to the embodiment.

### DESCRIPTION

Hereinafter, embodiments of an information processing system, an information processing device, a terminal device, an information processing method, a program, and a recording medium (computer program product) according to the present disclosure will be described in detail with reference to the drawings. Note that, in the following description, components having substantially the same functions and configurations are denoted by the same reference signs, and redundant description will be made if necessary. In addition, the embodiments can be appropriately combined with other embodiments, modifications, and/or conventional techniques.

A problem to be solved by the present disclosure may be to support management of issues or information in the organization.

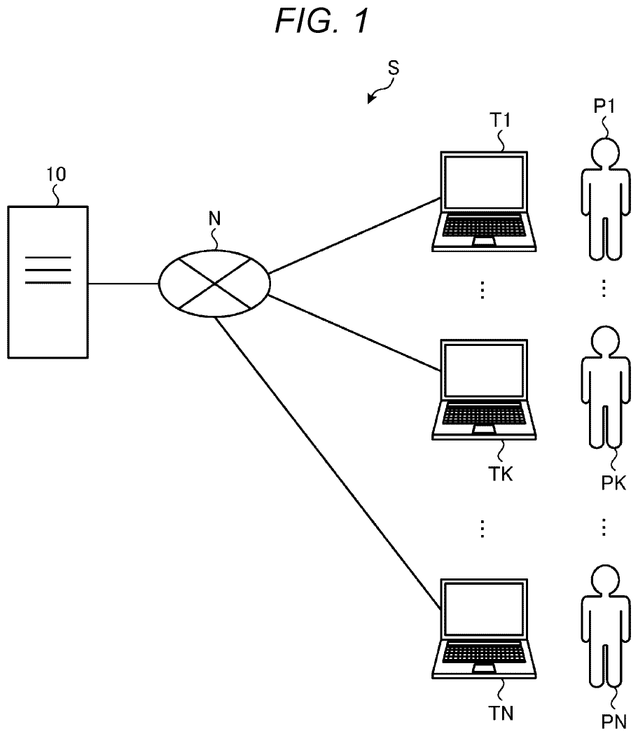

FIG. 1 is a schematic diagram for describing an outline of an information processing system S according to the present embodiment. The information processing system S according to the present embodiment may be a system that provides a management service that supports management of issues or information in operation and management of various organizations including companies. Note that a part or the whole of the information processing system S may be simply referred to as a system in the present disclosure.

The issue to be managed in the present disclosure may be, for example, a topic on which decision making such as a resolution is performed by a decision-making body of an organization, or a topic on which sharing, consultation, and reporting are performed at a body within a certain organization, and includes at least one agenda item. In addition, the information to be managed in the present disclosure may be, for example, various types of information regarding the issue. As an example, the information to be managed may be information indicating the issue or at least one agenda item included in the issue. As an example, the information to be managed may be information prepared for an action taken on each agenda item in the organization such as decision-making, sharing, consultation, or reporting, information used in the action on each agenda item, or information generated in the action on each agenda item. As an example, the information to be managed may be information indicating a relationship between issues or information, such as another issue, another agenda item, or another action. Note that, in the present embodiments, a target of management supported by the management service provided by the information processing system S, that is, the above issue or information may be described as the topic or information associated with the topic (topic-associated information), or may be collectively and simply described as a management target.

In the following description of the embodiments and the like, a case will be exemplified where a corporate issue or information associated with the corporate issue is mainly handled as the management target and a decision is made by the decision-making body. Therefore, descriptions such as the corporate issue and corporate issue management processing can be appropriately interpreted as the issue or information to be managed, issue management processing or information management processing, or the like. In addition, the decision-making body or the like can be appropriately interpreted as a body. In addition, decision-making, resolution, or the like can be appropriately interpreted as an action.

Here, examples of the decision-making body of the organization may include meeting bodies such as the board of directors, management meeting, operating officer meeting, business division meeting, general manager meeting, and section manager meeting. The decision-making body may be a body or a meeting body defined by laws related to organizations such as the Companies Act, or may be the one defined internally by an internal rule, or the like. The meeting body may have a secretariat engaged in the meeting body. The decision-making body may operate the organization by making a decision based on, for example, the corporate issue. As an example, the decision-making body may make various decisions such as introducing a benefit program to increase the satisfaction level of employees, receiving a loan to stabilize cash flow, and setting a policy of focusing more on patents and filing applications.

As illustrated in FIG. 1, the information processing system S of the present embodiment may include an information processing device 10 and at least one terminal device T1 to TN. In the information processing system S, the information processing device 10 and each of the at least one terminal device T1 to TN may be configured to communicate with each other via a network N.

The at least one terminal device T1 to TN of the present embodiment may be operated by users P1 to PN, respectively. Note that, in the following description, the terminal device T1 operated by the user P1 will be described as an example when a distinction is not made among the at least one terminal device T1 to TN. In addition, the terminal devices T1 to TN may be collectively referred to as a terminal device T when a distinction is not made among the at least one terminal device T1 to TN. Similarly, the users P1 to PN may be collectively referred to as a user P when a distinction is not made among the users P1 to PN.

The terminal device T1 may be operated by, for example, the user P1 who is a member of the organization. The user P1 may consider the agenda item, proposes the agenda item to the decision-making body of the organization, reconsiders the agenda item in response to a result of discussion (resolution) of the decision-making body, and executes business in accordance with the resolution.

The terminal device TK may be operated by, for example, the user PK who is a member of the secretariat of the meeting body (decision-making body) of the organization. The user PK may support decision-making by the decision-making body by sending an invitation notice to a meeting for discussing the proposed agenda item or by other means.

The terminal device TN may be operated by, for example, the user PN who is a member of the decision-making body of the organization. The user PN may confirm information regarding a meeting he/she is scheduled to participate in, such as the invitation notice and materials and the status of each corporate issue, and makes a decision.

Next, specific configurations of the information processing device 10 and the terminal device T1 of the embodiment will be described.

### Information Processing Device 10

The information processing device 10 of the present embodiment may be, for example, a device that is connected to a client device by communication and performs various types of processing in response to a request from the client device. The information processing device 10 may be, for example, a server device managed by a business operator side that provides the management service. The information processing device 10 may provide the management service to the terminal device T1 in response to a result of input or an operation regarding the corporate issue received from the terminal device T1, which is the client device, via the network N.

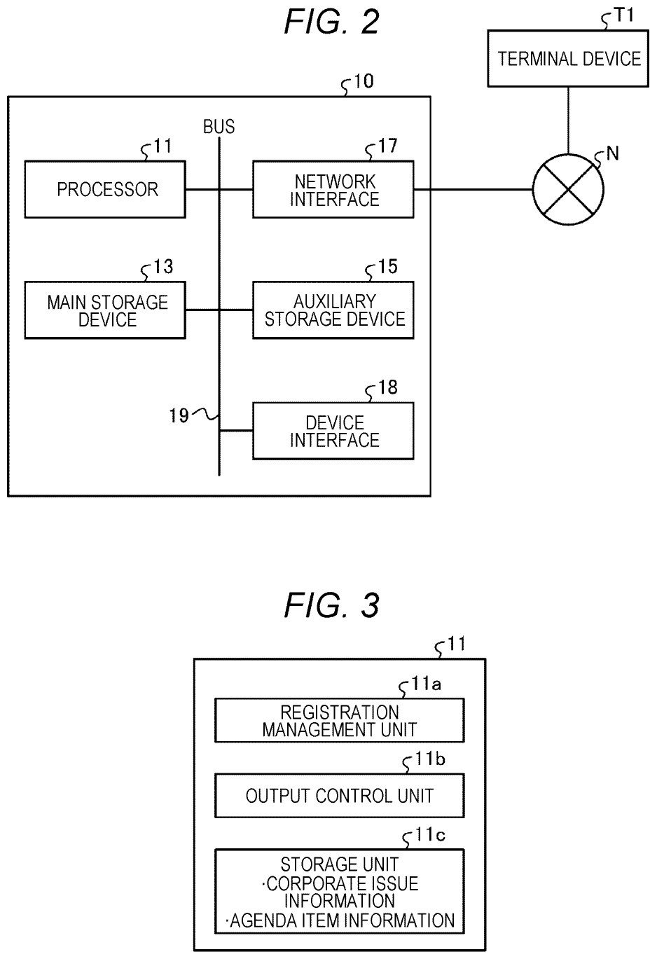

FIG. 2 is a block diagram illustrating an example of a hardware configuration of the information processing device 10 according to the embodiment. For example, as illustrated in FIG. 2, the information processing device 10 may have a configuration similar to that of a general computer, and include, as an example, a processor 11, a main storage device (memory) 13, an auxiliary storage device (memory) 15, a network interface 17, and a device interface 18. The processor 11, the main storage device 13, the auxiliary storage device 15, the network interface 17, and the device interface 18 may be connected to be capable of communicating with each other via, for example, a bus 19.

Note that FIG. 2 may illustrate the information processing device 10 in which each component has one unit, but the invention may not be limited thereto. The information processing device 10 may have a plurality of same components. In addition, one information processing device 10 may be illustrated in FIG. 2, but software may be installed in a plurality of computers, and each of the plurality of computers may execute the same part or different parts of processing of the software. In this case, there may be a form of distributed computing in which each of the plurality of computers communicates via the network interface 17 or the like to execute processing. That is, the information processing device 10 according to the embodiment may be configured as a system that implements various functions to be described later by one or a plurality of computers executing commands stored in one or a plurality of storage devices.

Various computations of the information processing device 10 may be executed in parallel processing using one or a plurality of processors or using the plurality of computers via the network. In addition, various computations may be distributed to a plurality of computing cores in the processor and executed in parallel processing. In addition, a part or the whole of the processing, means, and the like of the present disclosure may be executed by at least one of a processor and a storage device provided on a cloud capable of communicating with the information processing device 10 via the network N. As described above, the processing of the information processing system S in the present embodiment may be in a form of parallel computing by one or a plurality of computers.

The processor 11 may be an electronic circuit (a processing circuit, a processing circuitry, a central processing unit (CPU), a graphics processing unit (GPU), a field programmable gate array (FPGA), an application specific integrated circuit (ASIC), or the like) including a control device and a computing device of the information processing device 10. In addition, the processor 11 may be a semiconductor device or the like including a dedicated processing circuit. The processor 11 may be implemented by an optical circuit using an optical logic element without being limited to an electronic circuit using an electronic logic element. In addition, the processor 11 may include a computing function based on quantum computing.

The processor 11 can perform computational processing based on data and software (program) input from each device or the like of the internal configuration of the information processing device 10, and output a computation result and a control signal to each device or the like. The processor 11 may control each component constituting the information processing device 10 by executing an operating system (OS) of the information processing device 10, an application, or the like.

The information processing device 10 in the present embodiment may be implemented by one or a plurality of processors 11. Here, the processor 11 may refer to one or a plurality of electronic circuits disposed on one chip, or may refer to one or a plurality of electronic circuits disposed on two or more chips or two or more devices. When the plurality of electronic circuits are used, the electronic circuits may communicate in a wired or wireless manner.

The main storage device 13 may be a storage device that stores commands executed by the processor 11, various types of data, and the like, and information stored in the main storage device 13 is read by the processor 11. The auxiliary storage device 15 may be a storage device other than the main storage device 13. Note that each of these storage devices may mean any electronic component capable of storing electronic information, and may be a semiconductor memory. The semiconductor memory may be either a volatile memory or a nonvolatile memory. A storage device for storing various types of data used in the information processing device 10 according to the embodiment may be implemented by the main storage device 13 or the auxiliary storage device 15, or may be implemented by a built-in memory built in the processor 11. For example, a storage unit in the embodiment may be implemented by the main storage device 13 or the auxiliary storage device 15.

To one storage device (memory), a plurality of processors may be connected (coupled), or the single processor 11 may be connected. A plurality of storage devices (memories) may be connected (coupled) to one processor. When the information processing device 10 in the embodiment includes at least one storage device (memory) and a plurality of processors connected (coupled) to the at least one storage device (memory), at least one processor among the plurality of processors may be connected (coupled) to the at least one storage device (memory). In addition, this configuration may be achieved by the storage device (memory) and the processor 11 included in a plurality of computers. Furthermore, the storage device (memory) may be integrated with the processor 11 (for example, a cache memory including an L1 cache and an L2 cache).

The network interface 17 may be an interface for connecting to the network N in a wireless or wired manner. As the network interface 17, an appropriate interface such as one conforming to an existing communication standard may be used. The network interface 17 may exchange information with an external device connected via the network N. Note that the network N may be any of a wide area network (WAN), a local area network (LAN), a personal area network (PAN), and the like, or may be a combination thereof, and may be one that allows exchange of information between the information processing device 10 and the external device. Examples of the WAN include the Internet, examples of the LAN include IEEE802.11 and Ethernet (registered trademark), and examples of the PAN include Bluetooth (registered trademark) and near field communication (NFC).

The device interface 18 may be an interface such as a universal serial bus (USB) directly connected to an output device such as a display device, an input device, and an external device. In addition, the external device may be a storage device (memory), a network storage, a storage such as an HDD, or the like. In addition, the external device may be a device having some functions of components of the information processing device 10 according to the embodiment. That is, the information processing device 10 may transmit or receive a part or the whole of a processing result of the external device.

FIG. 3 is a block diagram illustrating an example of a functional configuration of the information processing device 10 according to the embodiment. For example, as illustrated in FIG. 3, the information processing device 10 may have functions as a registration management unit 11a, an output control unit 11b, and a storage unit 11c. Specifically, at least one program for implementing each function of the information processing device 10 may be stored in, for example, the main storage device 13 or the auxiliary storage device 15. The processor 11 can implement each function of the information processing device 10 by reading and executing the program stored in the main storage device 13, the auxiliary storage device 15, or the like.

The registration management unit 11a may perform information communication with the terminal device T1 via the network, for example. Specifically, the registration management unit 11a may receive input of information regarding the corporate issue from the terminal device T1. In addition, the registration management unit 11a may store the received information regarding the corporate issue in the storage unit 11c.

Specifically, the registration management unit 11a may assign an identifier (for example, an issue identification (ID)) for uniquely identifying the corporate issue to each received corporate issue. In addition, the registration management unit 11a may store the received information regarding the corporate issue in the storage unit 11c in direct or indirect association with the issue ID. Therefore, in the information processing device 10 according to the embodiment, the information regarding the corporate issue may be managed together with other information regarding the same corporate issue or information regarding another corporate issue in association with the issue ID or another ID managed in association with the issue ID.

The output control unit 11b may perform, for example, information communication with the terminal device T1 via the network. Specifically, the output control unit 11b may generate display information for displaying the information regarding the corporate issue, and may output the display information to the terminal device T1. Note that each piece of the display information may include layout information. As an example, the output control unit 11b may generate display information that displays information indicating a plurality of registered corporate issues, and may output the display information to the terminal device T1.

The storage unit 11c may store various programs executed in the information processing device 10. In addition, the storage unit 11c may store the information regarding the corporate issue. Note that the information regarding the corporate issue may include document data or voice data uploaded from the terminal device T1.

### Terminal Device T1

The terminal device T1 of the present embodiment may transmit and receive the information regarding the corporate issue to and from the information processing device 10 in the management service.

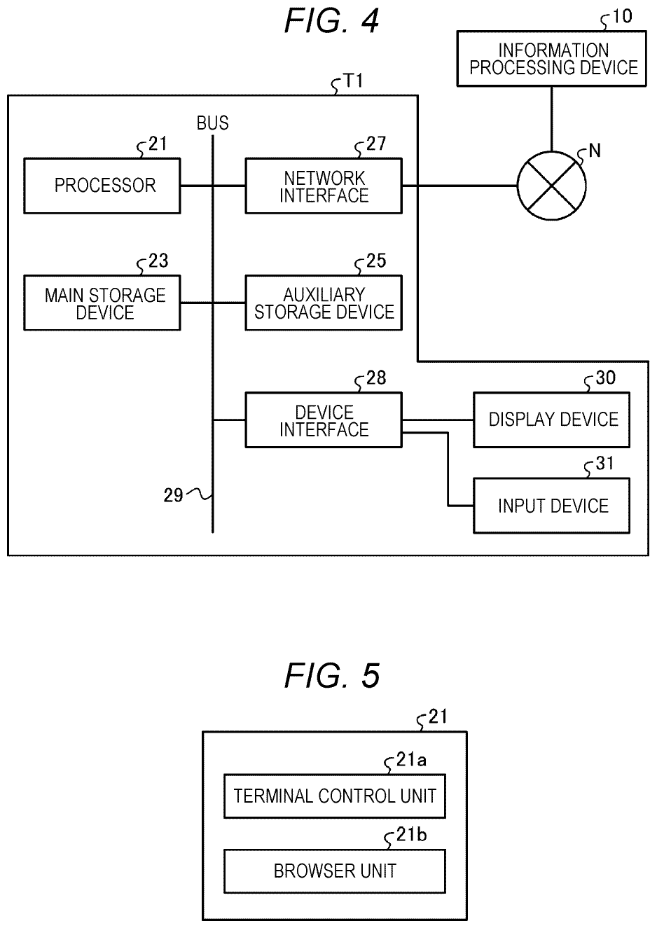

FIG. 4 is a block diagram illustrating an example of a hardware configuration of the terminal device T1 according to the embodiment. As illustrated in FIG. 4, the terminal device T1 of the present embodiment may have a configuration similar to that of a general computer, and include, as an example, a processor 21, a main storage device (memory) 23, an auxiliary storage device (memory) 25, a network interface 27, a device interface 28, a display device 30, and an input device 31. The processor 21, the main storage device 23, the auxiliary storage device 25, the network interface 27, and the device interface 28 may be connected to be capable of communicating with each other via, for example, a bus 29. The display device 30 and the input device 31 are connected to the device interface 28.

The processor 21, the main storage device 23, the auxiliary storage device 25, the network interface 27, and the device interface 28 may have hardware configurations similar to those of the processor 11, the main storage device 13, the auxiliary storage device 15, the network interface 17, and the device interface 18, respectively, and the description thereof will be omitted.

The display device 30 may be, for example, a display device such as a liquid crystal display (LCD), a cathode ray tube (CRT), a plasma display panel (PDP), or an organic electro luminescence (EL) panel. Based on an instruction from the processor 21, the display device 30 may display, for example, each screen for displaying the information regarding the corporate issue to be described later.

The input device 31 may be, for example, a device such as a keyboard, a mouse, or a touch panel. The input device 31 may receive various operation inputs by the user P1, for example, in corporate issue management processing to be described later. The input device 31 may output a result of the operation input received from the user P1 to the processor 21.

Note that other external devices such as a camera, a microphone, motion capture, and various sensors may be connected to the terminal device T1 via the device interface 18.

FIG. 5 is a block diagram illustrating an example of a functional configuration of the terminal device T1 according to the embodiment. As illustrated in FIG. 5, the terminal device T1 of the present embodiment may have functions as a terminal control unit 21a and a browser unit 21b. Specifically, at least one program for implementing each function of the terminal device T1 may be stored in, for example, the main storage device 23 or the auxiliary storage device 25. The processor 21 can implement each function of the terminal device T1 by reading and executing the program stored in the main storage device 23, the auxiliary storage device 25, or the like.

For example, the terminal control unit 21a activates the browser unit 21b in response to an instruction from the user.

The browser unit 21b may be, for example, a general web browser, and execute processing according to hyper text markup language (HTML) data, a script (for example, Java (registered trademark) Script), or the like. When being activated, the browser unit 21b transmit an initial access URL to the information processing device 10 for access.

The browser unit 21b may display data including text data and image data received from the information processing device 10 on the display device 30 of the terminal device T1 in a predetermined form. More specifically, in the corporate issue management processing, the browser unit 21b may display the information regarding the corporate issue on the display device 30 of the terminal device T1 in the predetermined form based on the display information received from the information processing device 10.

### Procedure of Corporate Issue Management

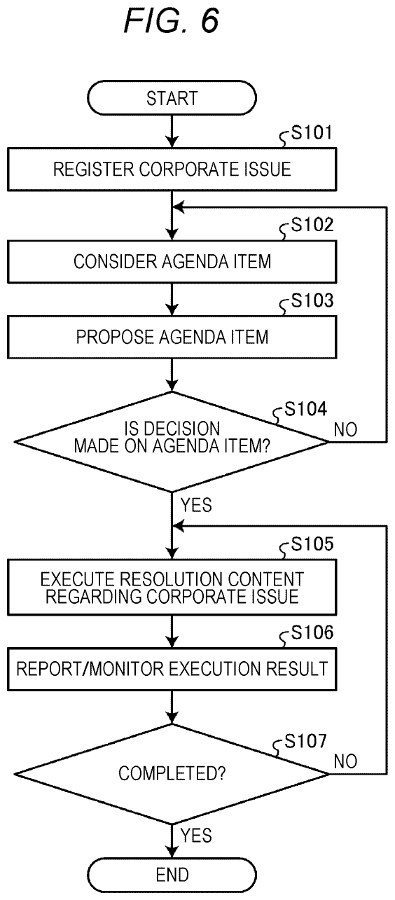

Next, management of a life cycle of the corporate issue performed by utilizing the management service provided by the information processing system S according to the embodiment will be described. FIG. 6 is a flowchart illustrating an example of a procedure of corporate issue management regarding the corporate issue that requires decision-making by the decision-making body having the secretariat according to the embodiment.

First, for example, the user P1 who is the member of the organization may register the corporate issue in the information processing system S by inputting the information regarding the corporate issue using the terminal device T1 (S101). Note that the information regarding the corporate issue may be input by the user PK of the secretariat or the user PN of the decision-making body.

Then, for example, the user P1 may register an agenda item included in the registered corporate issue (S102), then raise and propose the registered agenda item to the decision-making body (S103).

The user PK of the secretariat of the decision-making body may manage a meeting for the decision-making body for discussing the agenda item. In addition, the user PN of the decision-making body may make a decision (which herein may be referred to as decision-making) on the agenda item proposed at the meeting as the member of the decision-making body. In addition, when decision-making is performed by the decision-making body, the user PK of the secretariat may register the content of the meeting, such as a discussion and a conclusion (resolution content) by the decision-making body, in the information processing system S.

As a result of decision-making by the decision-making body on the proposed agenda item, if it is determined to reconsider the agenda item by bringing it back or by other means, or there is an agenda item on which a decision has not yet been made (S104: No), the user P1 may perform consideration (S102) and proposal (S103) again while referring to the registered content of the meeting by the decision-making body.

On the other hand, if a decision has been made on the proposed agenda item by the decision-making body (S104: Yes), for example, the user P1 may execute a resolution content by the decision-making body (S105) and register an execution result in the information processing system S to report the execution result to the decision-making body. In addition, for example, the user PN may monitor the corporate issue by referring to the registered execution result (S106). Thereafter, until an action on the corporate issue is completed (S107: Yes), proposal of a new or reconsidered agenda item, execution of the resolution content (S105), and reporting (S106) may be repeated (S107: No).

### Flow of Corporate Issue Management Processing

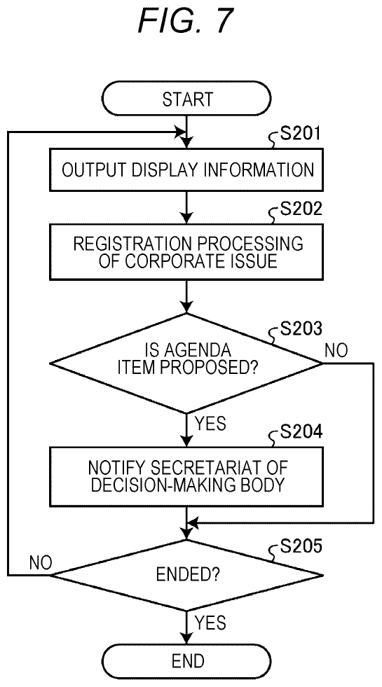

Next, an example of corporate issue management processing implemented by the information processing device 10 according to the embodiment will be described. FIG. 7 is a flowchart illustrating an example of a flow of the corporate issue management processing according to the present embodiment.

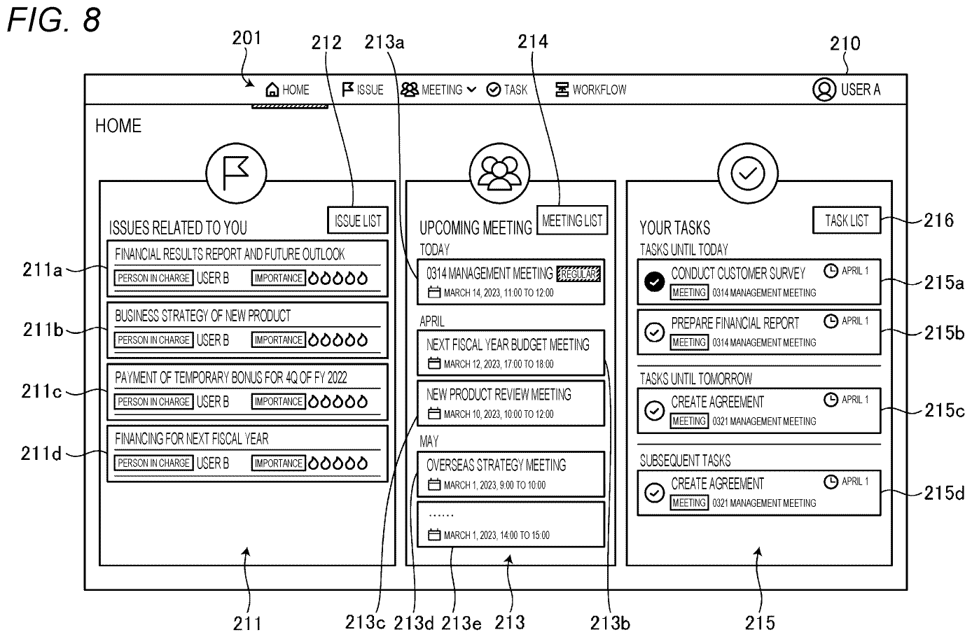

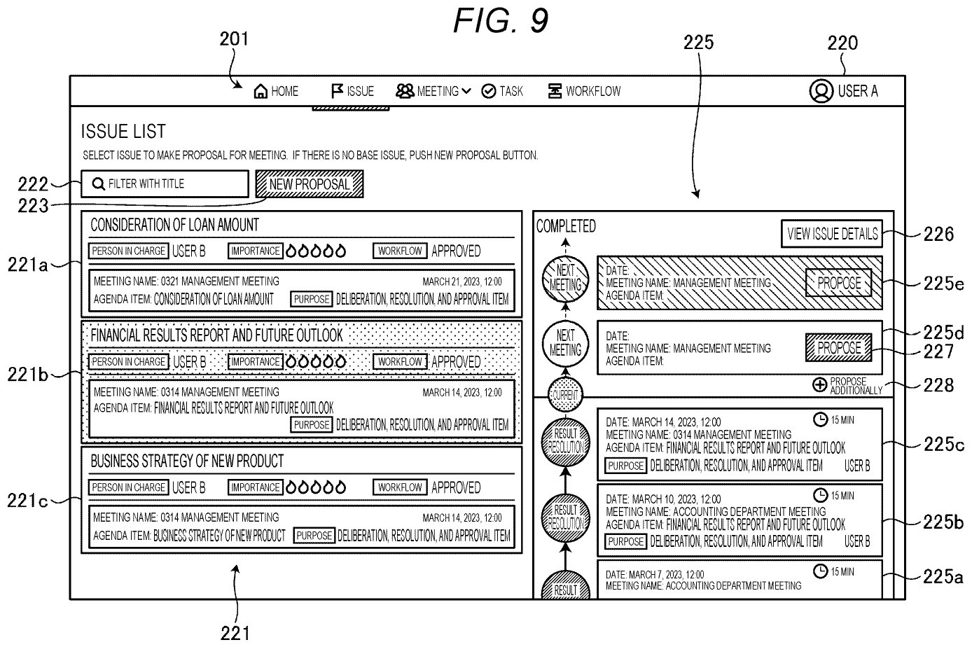

For example, the output control unit 11b may output the display information to the terminal device T in response to access from the terminal device T using the initial access URL (S201). It may be preferable that, for example, if displayed immediately after the access to the system, the display information may include display that allows the user to take a bird's-eye view of the functions of the entire system and information managed by the system related to the user, as illustrated in FIG. 8. Note that this display information may be information for displaying a screen at the time of previous logout, such as screens illustrated in FIGS. 9 to 15, and can be set as appropriate.

The registration management unit 11a may execute corporate issue registration processing based on, for example, output in response to a user operation from the terminal device T (S202).

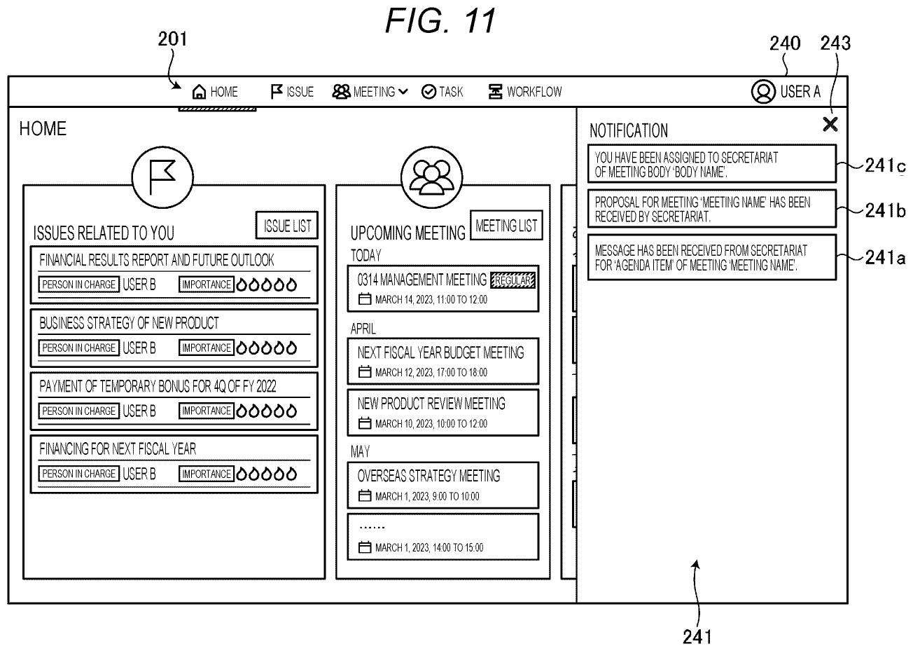

For example, if the agenda item has been proposed (raised) for a certain corporate issue (S203: Yes), the registration management unit 11a can further generate notification information for notifying the user PK of the secretariat of the decision-making body set for the item that the agenda item has been proposed (S204). The notification information may be displayed on, for example, a screen (see FIG. 11) when the user PK accesses the information processing device 10 from the terminal device TK through the web browser. In addition, the notification may be, for example, a notification transmitted to the outside of the system, such as an email or an external chat tool.

In addition, the registration management unit 11a, for example, may determine whether to end the corporate issue management processing (S205). If it is not determined to end the corporate issue management processing (S205: No), for example, the processing may return to S201 to output the display information to the terminal device T. On the other hand, if it is determined to end the corporate issue management processing (S205: Yes), the processing may end.

FIGS. 8 to 15 are figures illustrating examples of display screens displayed as web browser screens on at least one display device 30 of the terminal device T in the corporate issue management processing according to the embodiment. Note that, when the initial access URL is transmitted from the terminal device T1, the information processing device 10 may authenticate the user connected to the system by, for example, causing the user to log in using an ID, a password, and the like if necessary. In a configuration for performing user authentication, the output control unit 11b may output, for example, display information for displaying a screen for inputting login information such as an ID and a password to the terminal device T in response to the access from the terminal device T using the initial access URL. Each of the screens illustrated in FIGS. 8 to 15 can be a screen accessed from the screen for inputting the login information.

Note that, in the present disclosure, an operation button may be an example of an area operated by the user for a predetermined purpose, and may be an image such as an icon, display of text, or another display.

Note that, in the present disclosure, screen transition or transition may be an example of displaying pieces of different information on the screen. Therefore, when the pieces of different information are displayed, displaying may not be limited to screen transition, and may be performed in such a manner that a new screen is displayed on a previous screen so as to superimpose a plurality of screens, another window is opened for the display, or the like, as illustrated in FIG. 11.

FIG. 8 is a figure illustrating an example of a display screen 210 displayed on the display device 30 of the terminal device T in the corporate issue management processing according to the embodiment.

The display screen 210 can function as, for example, a home screen (top screen). For example, when “Home” on a navigation bar 201 is operated, the output control unit 11b may display the display screen 210 in FIG. 8 that is a home screen of the system. It may be preferable that the display screen 210 is displayed immediately after access to the system to prevent the user who has made accessed the system from overlooking the screen. In addition, it may be preferable that the display screen 210 includes the display that allows the user to take a bird's-eye view of the functions of the entire system and the information managed by the system related to the user. As described above, the information processing system S according to the embodiment may have a function of presenting at least one of a topic such as the corporate issue related to the user and information based on a predetermined rule (information associated with the topic) such as schedules of a meeting and task managed in association with the topic. The predetermined rule may be, for example, a company regulation or the like for determining the type, order, or the like of a meeting at which the agenda item should be raised. For example, the predetermined rule may be a company rule or the like that defines a meeting at which a proposal or decision-making should be obtained based on the amount of money or the content. For example, the predetermined rule may be a rule for an internal meeting, approval request, or the like. For example, the predetermined rule may be a law such as the Companies Act.

The display screen 210 may include a display area 211 for presenting corporate issues related to the user P accessing from the terminal device T. For example, as illustrated in FIG. 8, the display area 211 of the display screen 210 may present the corporate issues related to the user P as “Issues related to you.” FIG. 8 may illustrate a case where, for example, corporate issues 211a to 211d with high importance among the corporate issues related to the user P accessing from the terminal device T are displayed as “Issues related to you.” Each of the corporate issues 211a to 211d may include, for example, display of a title, person in charge, and importance of the corporate issue.

Note that the corporate issues presented in the display area 211 may not be limited to those with high importance, and can be arbitrarily set as, for example, corporate issues for which a notification whose transmission destination includes the user P has been transmitted or for which a notification has not yet been checked, corporate issues for which information has been added because a meeting has been held or a task has been executed recently, corporate issues for which an upcoming meeting may be scheduled to be held or a task that has not yet been executed has a deadline, corporate issues extracted based on a combination thereof, or the like.

In addition, the display area 211 may include display of an operation button 212 for instructing display of “Issue list” for displaying a list of the corporate issues. For example, when the operation button 212 for instructing display of “Issue list” is operated, the output control unit 11b may display a display screen 220 in FIG. 9 including display of the list of the corporate issues.

Note that “List” in the present embodiment may not be limited to display of all items on one page, and include display over a plurality of pages.

In addition, the display screen 210 may include a display area 213 for presenting meetings managed in association with the corporate issues related to the user P accessing from the terminal device T. Here, managing the meetings in association with the corporate issues may mean managing the meetings in direct association with the corporate issues, or may mean managing the meetings in indirect association with the corporate issues via at least one piece of information to be managed, such as another agenda item or meeting, or another corporate issue. That is, in the present disclosure, management in association may mean management in direct or indirect association. For example, as illustrated in FIG. 8, the display area 213 of the display screen 210 may present the meetings associated with the corporate issues related to the user P as “Upcoming meetings.” FIG. 8 may illustrate a case where, for example, meetings 213a to 213e for which the user P is included as a participant among the meetings associated with the corporate issues related to the user P accessing from the terminal device T are displayed in order of date from earliest as the “Upcoming meetings.” Each of the meetings 213a to 213e may include, for example, display of a title of the meeting and a date and time when the meeting is scheduled to be held. In addition, each of the meetings 213a to 213e may include display indicating that the meeting is a regular one, for example, like the meeting 213a.

Note that the meeting presented in the display area 213 may not be limited to a meeting for which the user P is included as a participant, and can be arbitrarily set as, for example, a meeting for which the user P has proposed the agenda item.

As described above, the information processing system S according to the embodiment can display information based on the predetermined rule (topic-associated information) such as a schedule of the meeting managed in direct or indirect association with the topic such as the corporate issue related to the user P accessing from the terminal device T, that is, a schedule of a future meeting regarding the corporate issue. As a result, the user P can easily check the schedule of the future meeting.

In addition, the display area 213 may include display of an operation button 214 for instructing display of “Meeting list” for displaying a list of the meetings. For example, when the operation button 214 for instructing display of “Meeting list” is operated, the output control unit 11b may display a display screen including display of the list of the meetings. For example, the display screen including the display of the list of the meetings may be capable of narrowing down meetings to be displayed in the list based on a search keyword input by the user P and a plurality of pieces of meeting information registered, by including display of an input field for inputting the search keyword or by other means. As a result, the user P can easily check the total amount of the meetings by the decision-making bodies while maintaining the browsability, and can easily access desired meeting information based on the predetermined rule (topic-associated information), such as a schedule and a result of a discussion regarding the corporate issue (topic) or the agenda item.

In addition, the display screen 210 may include a display area 215 for presenting tasks managed in direct or indirect association with the corporate issues related to the user P accessing from the terminal device T. For example, as illustrated in FIG. 8, the display area 215 of the display screen 210 may present the tasks associated with the corporate issues related to the user P as “Your tasks.” FIG. 8 may illustrate a case where, for example, tasks 215a to 215d the user P is scheduled to execute among the tasks associated with the corporate issues related to the user P accessing from the terminal device T are displayed as “Your tasks” in order of deadline from earliest. In the example in FIG. 8, the tasks 215a and 215b may be displayed as “Tasks until today,” the task 215c may be displayed as “Tasks until tomorrow,” and the task 215d may be displayed as “Tasks after that.” Note that the categories of the tasks displayed as “Your tasks” may not be limited to the example in FIG. 8, and may be, for example, two categories of the “Tasks until today” and “Tasks from tomorrow onwards,” or four or more categories. In addition, an item (category) of each category of the tasks displayed as “Your tasks” may also be arbitrary. Each of the tasks 215a to 215d may include, for example, display of a title, deadline, status, and related meeting of the task.

As described above, the information processing system S according to the embodiment may manage the tasks based on the predetermined rule (topic-associated information) in direct or indirect association with the corporate issue (topic), and thus can display information based on the predetermined rule (topic-associated information) such as the schedule and the status of the tasks that are the matters to be executed by the user P accessing from the terminal device T. In other words, the information processing system S according to the embodiment can display the schedule and the status of the tasks that are matters managed in direct or indirect association with the meetings related to the user P accessing from the terminal device T. As a result, the user P can easily check his/her tasks regarding the agenda items of the past meeting and/or the future meeting. In addition, the user P can easily grasp the progress of these tasks, and can also easily consider the execution order. For example, the user P can easily check that the task 215a has been executed and the task 215b has not been executed among the tasks 215a and 215b displayed as the “Tasks until today” whose deadline is today.

In addition, the display area 215 may include display of an operation button 216 for instructing display of “Task list” for displaying a list of the tasks. For example, when the operation button 216 for instructing display of “Task list” is operated, the output control unit 11b may display a display screen including display of the list of the tasks. For example, the display screen including the display of the list of the tasks may be capable of narrowing down tasks to be displayed in the list based on the search keyword input by the user P or designation of the status, and a plurality of registered tasks or the like, by including display of an input field for inputting the search keyword and a selection field for selecting the status, or by other means. As a result, the user P can easily check the progress and a total amount of the tasks based on the predetermined rule to be executed (topic-associated information) while maintaining the browsability, and can easily access desired information (topic-associated information) such as a content of the task regarding the corporate issue (topic) or the agenda item.

FIG. 9 is a figure illustrating an example of the display screen 220 displayed on the display device 30 of the terminal device T in the corporate issue management processing according to the embodiment.

The display screen 220 can function as, for example, a display screen of “Issue list” including the display of the list of the corporate issues. For example, when the operation button 212 for instructing the display of “Issue list” is operated on the display screen 210 in FIG. 8, or when the “Issue” on the navigation bar 201 is operated on an arbitrary display screen, the output control unit 11b may display the display screen 220 in FIG. 9 including the list of the corporate issues. The display screen 220 may present the schedule or expectation of the future meeting based on the company rule, in addition to the past discussion or resolution result of the meeting, regarding the meeting related to the user P who has made access. As described above, the information processing system S according to the embodiment may have a function of presenting information based on the predetermined rule (topic-associated information) that is at least one of the past discussion or resolution result and the future schedule or expectation regarding the meeting managed based on the predetermined rule in association with the corporate issue (topic) related to the user. As a result, it may be possible to reduce labor required for holding the meeting.

The display screen 220 may include a display area 221 for presenting a list of the corporate issues related to the user P accessing from the terminal device T. FIG. 8 may illustrate a case where corporate issues 221a to 221c related to the user P accessing from the terminal device T are displayed in the list. Each of the corporate issues 221a to 221c may include, for example, display of a title, person in charge, importance, and approved/unapproved status in the workflow of the corporate issue, and the meeting for the agenda item included in the corporate issue. The display of the meeting may include, for example, display of a meeting name, date and time, agenda item, and a purpose regarding the meeting that has recently been held. Note that the display of the meeting may be a meeting schedule based on the predetermined rule such as the next meeting.

In addition, the display screen 220 may include, for example, display of an input field 222 for inputting the search keyword, and may be capable of narrowing down the corporate issues to be displayed in the list based on the search keyword input by the user P and the plurality of registered corporate issues. As a result, the user P can easily check a total amount of the corporate issues (topic) while maintaining the browsability, can easily access desired issue information based on the predetermined rule (topic-associated information), such as the agenda item, meeting schedule, discussion schedule, and discussion result regarding the corporate issue, and can bring up the issue information for the meeting. The narrowing-down may be filtering or the like.

In addition, the display screen 220 may include, for example, display of an operation button 223 for instructing “New proposal” for newly registering the corporate issue serving as a base for making a proposal for the meeting, in addition to selecting and proposing the corporate issue displayed in the list for the meeting. For example, when the operation button 223 for instructing “New proposal” is operated, the output control unit 11b may display a display screen for registering the corporate issue and proposing the agenda item of the corporate issue for the meeting.

In addition, the display screen 220 may include, for example, a display area 225 for displaying information based on the predetermined rule such as a history and the future schedule or expectation regarding a meeting for making a decision on the agenda item included in the corporate issue selected from among the corporate issues displayed in the list in the display area 221.

FIG. 9 may illustrate the display area 225 where the corporate issue 221b in the display area 221 has been selected. In the example in FIG. 9, the display area 225 may include display of meetings 225a to 225e managed in direct or indirect association with the selected corporate issue 221b. Each of the meetings 225a to 225e may be arranged in the order of the workflow of the corporate issue, that is, displayed in time series. The display area 225 may include display of an icon indicating a “Current” position in the time series.

In addition, the display area 225 may include display of the “Past” meetings 225a to 225c in the time series. The past meetings may include, for example, display of the result of decision-making regarding the agenda item included in the selected corporate issue. The example in FIG. 9 may include display of icons indicating that a “Resolution” has been made on the agenda item of the corporate issues selected at the meetings 225a to 225c. In addition, the display area 225 may include a display indicating an outline of each meeting together with the icons indicating the result of the decision-making. The display indicating the outline of each meeting may include display of the date and time of the meeting, meeting name, agenda item, time required for decision-making on the agenda item, purpose, and person in charge.

In addition, the display area 225 may include display of the “Future” meetings 225d and 225e in the time series. That is, the display area 225 may include display of information based on the predetermined rule such as the future plan or expectation regarding the meeting related to the selected corporate issue. The future meeting may be, for example, a meeting managed in association with the selected corporate issue, and may be, for example, a meeting scheduled or expected to be held in accordance with the workflow (predetermined rule). The “Future” meetings 225d and 225e may be displayed together with, for example, a “Next meeting” icon indicating that the meeting is scheduled or expected to be held.

The display area 225 may also include display of an operation button 226 reading “View issue details” for instructing display of detailed information on the selected corporate issue. For example, when the “View issue details” operation button 226 is operated, the output control unit 11b may display a display screen including the detailed information on the selected corporate issue.

In addition, in the display area 225, each of the “Future” meetings 225d and 225e may include, for example, display of the name of the meeting scheduled or expected to be held in accordance with the workflow, and display of the operation button 227 reading “Propose” for instructing proposal of the agenda item for the meeting. For example, when the “Propose” operation button 227 is operated, the output control unit 11b may display a display screen for proposing the agenda item included in the selected corporate issue for the meeting including the display of the operation button 227.

In addition, the display area 225 may include, for example, display of an operation button 228 reading “Propose additionally” for instructing proposal of the agenda item for the meeting together with designation of the meeting for which the proposal is to be made. For example, when the “Propose additionally” operation button 228 is operated, the output control unit 11b may display a display screen for designating the meeting for which the proposal is to be made and proposing the agenda item for the designated meeting.

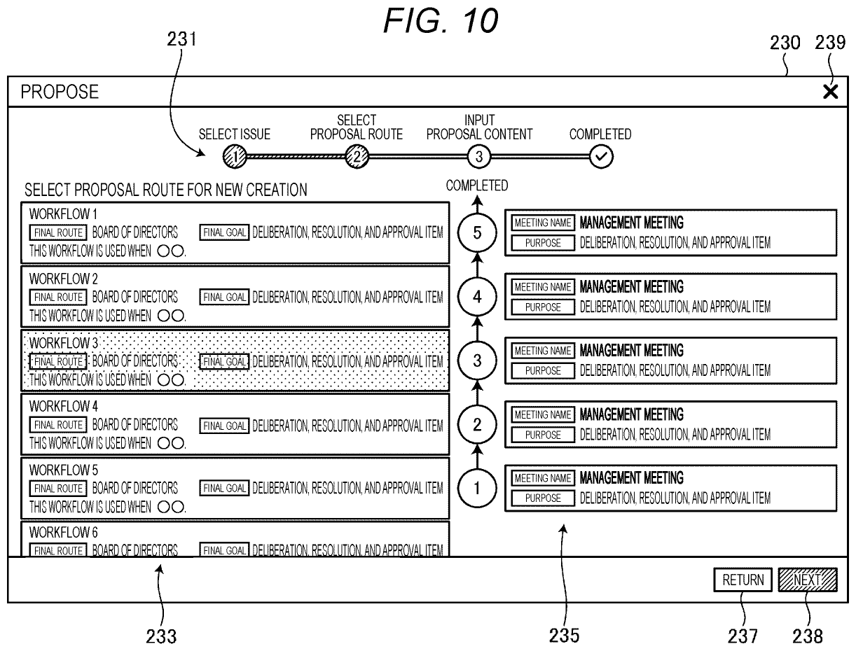

FIG. 10 is a figure illustrating an example of a display screen 230 displayed on the display device 30 of the terminal device T in the corporate issue management processing according to the embodiment. For example, a transition may be made to this screen by clicking the operation button 223 indicating new registration in the screen in FIG. 9.

The display screen 230 can function as, for example, a display screen for proposing the agenda item managed in direct or indirect association with the corporate issue regarding the corporate issue for the meeting for an arbitrary purpose such as deliberation, resolution, approval, consultation, and report. Specifically, the display screen 230 can function as a display screen for proposing the agenda item for the meeting for making a decision on the corporate issue, while referring to the meeting scheduled or expected to be held in accordance with the workflow (predetermined rule) registered in advance. As described above, the information processing system S according to the embodiment may have a function of presenting the meeting scheduled or expected to be held in accordance with the workflow registered in advance (topic-associated information) when proposing the corporate issue (topic) related to the user.

The display screen 230 can be expressed as a display screen for setting the meeting displayed in the display area 225 of the display screen 220 in FIG. 9. For example, in the display area 221 of the display screen 220 in FIG. 9, when a corporate issue for which the meeting to propose the agenda item has not been set is selected, the output control unit 11b may display the display screen 230 in FIG. 10. The display screen 230 includes a display 231 indicating the progress of the proposal. FIG. 10 may illustrate the display screen 230 where a proposal route is selected while the corporate issue is selected.

The display screen 230 may include, for example, a display area 233 for displaying candidates of the workflow registered in advance. Each of the candidates of the workflow in the display area 233 may include, for example, display of a final meeting by the decision-making body for the corporate issue such as “Final route,” a content of final decision-making on the corporate issue such as “Final goal,” and a description of the workflow.

This workflow can be defined in accordance with, for example, the content of the corporate issue, a law, company rule, or approval request regulation defining the meeting bodies, and the like. In addition, this workflow may be to propose a decision-making body or meeting that has made a decision on another corporate issue having similar corporate issue information such as a title and category of the corporate issue. For example, the registration management unit 11a may propose, to the user P, the workflow including the decision-making body or meeting according to information on the title, category, and amount of money defined in accordance with the regulations in advance. In the presented workflow, related internal agreements (for example, a content requiring decision-making by a certain decision-making body, the upper limit of the amount of money allowing decision-making, the order of deliberation in a case where the deliberation by a plurality of decision-making bodies is required, and the like) may be registered by the user of the system in advance. It may be preferable that a plurality of types of workflow are provided according to, for example, the decision-making body, the type of the corporate issue, the type of the agenda item, and the like.

In addition, the display screen 230 may include a display area 235 for displaying the meetings scheduled or expected to be held in accordance with the workflow regarding the selected candidate of the workflow. The display area 235 may display the meetings scheduled or expected to be held in order of date from earliest. A display of each meeting may include display of the meeting name and the purpose of the meeting.

The display screen 230 may also include display of an operation button 237 reading “Return” for instructing returning to the selection of the corporate issue, an operation button 238 reading “Next” for instructing proceeding to input of a proposal content, and an operation button 239 reading “□” for instructing cancellation of the proposal. For example, when the “Next” operation button 238 is operated, the output control unit 11b may display, for example, a display screen for inputting the proposal content such as agenda item information regarding at least one agenda item regarding the corporate issue for which decision-making is made by the decision-making body.

This display screen may be a display screen for receiving input or selection of the title (proposal title) of the proposed agenda item, decision-making body that makes a decision on the agenda item, purpose of the discussion, proposal content, proposal time, and message to the secretariat. In addition, the display screen may be capable of receiving input of an estimated time for the discussion and attachment of materials. In addition, in the input of the proposal content, input using a template registered in advance may be possible, it may be possible to reuse the proposal content for the previous meeting or the related meeting and the description of the proposal document by referring to or copying them, or input via input/output of a generation model to be described later may be possible.

Note that the information processing system S according to the embodiment can receive proxy proposal of the agenda item for the meeting by another user P instead of the user PN having proposal authority. For example, when the agenda item is proposed by proxy, the information processing system S may generate and transmit notification information for notifying the user PN having the proposal authority that the proxy proposal has been made. In addition, the information processing system S may receive review, approval, and denial of proxy proposal by the user PN. In addition, the information processing system S may receive permission of proxy proposal by the user PN to another user P. Also, the information processing system S may receive the user PN's correction of proxy proposal by another user P.

As described above, the information processing system S according to the embodiment can present to the user P the meetings scheduled or expected to be held in accordance with the predetermined rule such as the workflow registered in advance. As a result, the user P can appropriately propose the corporate issue (topic) and the agenda item, and smoothly operate the meeting.

FIG. 11 is a figure illustrating an example of a display screen 240 displayed on the display device 30 of the terminal device T in the corporate issue management processing according to the embodiment.

The display screen 240 can function as, for example, a notification screen for displaying notification information to the user P accessing from the terminal device T. The display screen 240 may include a display area 241 for presenting the notification information related to the user P accessing from the terminal device T. FIG. 11 may illustrate a case where notification information 241a to 241c related to the user P accessing from the terminal device T are displayed.

In addition, the display screen 240 may include an operation button 243 for instructing non-display of the display area 241 of the notification information. For example, when the operation button 243 is operated, the output control unit 11b may display the display screen 210 in FIG. 8.

Note that the notification information may include information generated by the system or created by another user to facilitate corporate issue management and holding of the meeting, such as a recommendation of the proposal content and/or proposal timing of the agenda item, a report of an execution result of the resolution content, and status management of the agenda item, which relate to the user P.

Note that it may be preferable that the notification information to the user PK of the secretariat that manages the meeting by the decision-making body includes a notification for notifying that the agenda item has been proposed for the meeting (for example, the notification information 241b). In addition, it may be preferable that the notification information to the user PN belonging to the decision-making body includes the invitation notice to the meeting for discussing and making a decision on the agenda item. In addition, it may be preferable that the type and content of the notification information to be notified can be changed according to a role of the user and settings.

For example, the notification information 241a may be an example of notification information to the user PN belonging to the decision-making body, reading “Message has been received from secretariat for ‘agenda item’ of meeting ‘meeting name.’” For example, the notification information 241b may be an example of notification information to the user PK of the secretariat that manages the meeting by the decision-making body, reading “Agenda item for meeting ‘meeting name’ has been received by secretariat.” For example, the notification information 241c may be an example of notification information to the user PN belonging to the decision-making body, reading “You have been assigned to secretariat of meeting body ‘meeting body name.’”

Note that it may be preferable that display of the notification to the user P, that is, the notification information is displayed on, for example, a dashboard-like screen (for example, the display screen 210 in FIG. 8) displayed immediately after login. As an example, the display screen 240 in FIG. 11 may be a screen in which the display area 241 of the notification information is displayed in a superimposed manner on the display screen 210 in FIG. 8. In addition, the notification information may be notification information for inviting the user PN belonging to the decision-making body to the meeting, reading “You have been invited to meeting ‘meeting name,’” for example. In addition, the notification information may be notification information to the user PK of the secretariat that manages the meeting by the decision-making body, reading “Message has been received for ‘agenda item’ of meeting ‘meeting name,’” for example. Also, the notification information may be notification information regarding the task managed in association with the issue (topic) like the meeting to the user PK of the secretariat that manages the meeting by the decision-making body or the user PN belonging to the decision-making body, reading “You have been assigned to person in charge of task ‘task name,’” for example.

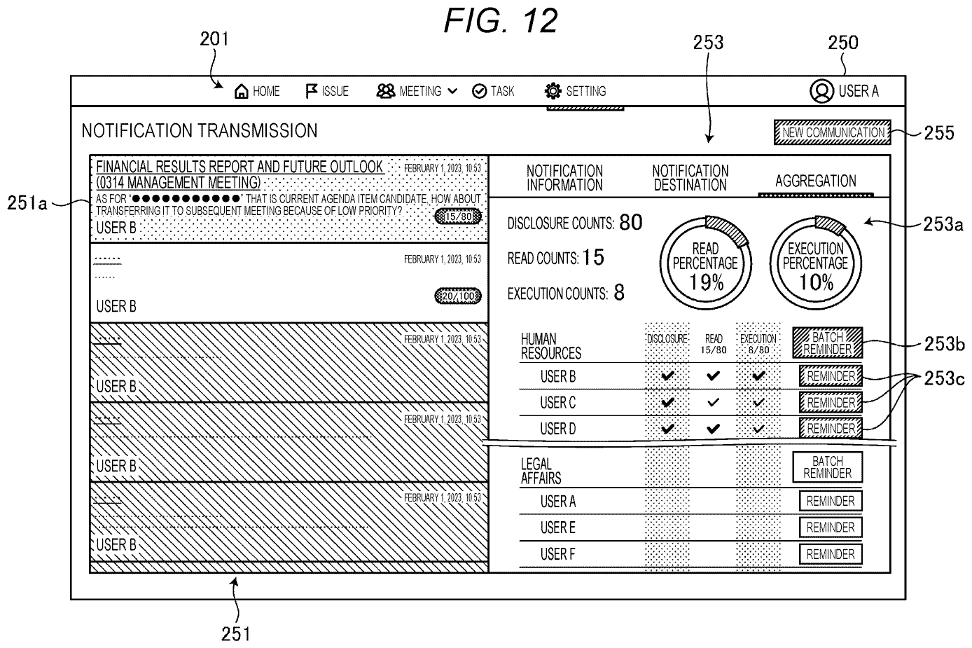

FIG. 12 is a figure illustrating an example of a display screen 250 displayed on the display device 30 of the terminal device T in the corporate issue management processing according to the embodiment.

The display screen 250 can function as, for example, a notification management screen for managing the notification information displayed to the user P accessing from the terminal device T.

The display screen 250 may include a display area 251 for presenting the notification information transmitted by the user PK accessing from the terminal device T or the information processing system S. Each piece of the notification information in the display area 251 may include, for example, display of a title, outline or beginning part of the content, transmission date and time, and sender. In addition, for example, a display indicating a browsing status of the notification information may be included. For example, in the example in FIG. 12, notification information 251a may include a display reading “15/80” indicating that 15 out of 80 users P who have been notified have browsed the notification information. Note that the transmitted notifications may not be limited to notifications transmitted by the user PK who has made access, and may be those transmitted by a group to which the user PK belongs, or may be those for which the user PK is not involved in the transmission but has browsing authority. In addition, it may be preferable from the viewpoint of information management that the information on the browsing status of the notification information is displayed only to a limited number of users such as a transmission source of the notification.

In addition, the notification may be any content that is desired to be transmitted to the user to be notified, in addition to the notification that the agenda item has been proposed for the meeting. For example, the notification may be to urge the user to take some action such as approval, or the like.

In addition, the display screen 250 may include a display area 253 for visually displaying a response status of the transmission destination regarding the transmitted notification information numerically and/or by using a graph or the like. FIG. 12 may illustrate the display area 253 where the notification information 251a has been selected. The display area 253 may include a display area 253a of an aggregation result of the response status, which numerically displays disclosure counts, read counts, and execution counts, and graphically display a reading percentage and an execution percentage using a numerical value and a graph. Here, the execution counts may be information indicating the number of people who have executed the task that has been requested to be executed by the notification information. Note that, in the display of the aggregation result of the response status, items numerically displayed and items graphically displayed may not be limited to the example in FIG. 12, and can be arbitrarily set. In addition, the display area 253 may include display of the response status regarding each user indicating whether or not the user is the notification destination, whether or not the user has read, and whether or not the user has executed.

In addition, the display screen 250 may display operation buttons 253b and 253c for instructing generation and transmission of notification information for prompting check of the notification and execution of the task according to the response status. For example, the operation button 253b reading “Batch reminder” for instructing collective generation and transmission of notification information for prompting all the users P in an arbitrary notification destination group, the users P who have not responded in the arbitrary notification destination group, or all the users P of the notification destination to check the notification and execute the task may be displayed. The arbitrary notification destination group may be a body, a department such as “Human Resources” or “Legal Affairs,” a position or rank, or a combination thereof. In addition, for example, an operation button 253c reading “Reminder” for instructing individual generation and transmission of the notification information for each user P may be provided.

As described above, by generating and transmitting various notifications (topic-associated information), the information processing system S according to the embodiment can recommend or remind a response of the user P regarding corporate issue (topic) management in which the user P is registered, notify the status or progress of the corporate issue or the agenda item (topic-associated information), or encourage a discussion. In addition, the information processing system S according to the embodiment can graphically or numerically display the response status at the notification destination of the various notifications (topic-associated information). In addition, the generation and transmission of the various notifications can be performed for each of the arbitrary notification destination groups such as for each department. In addition, a “transfer/movement” function implemented by generating and transmitting the various notifications, that is, a communication function by notification, a function of sharing a process and result of a discussion, or the like can be used not only by the user PK of the secretariat of the meeting but also by the user P of the department in charge of the case according to the nature of these functions. In addition, the functions can be used not only by the user P but also by each user group such as the department or secretariat, and by a proxy user. That is, the information processing system S according to the embodiment can flexibly support management of issues or information in the organization.

Note that the target to be graphically displayed may not be limited to the response status to the notification, and may be other information managed by the information processing system S in association with the corporate issue. For example, the information processing system S may display a display screen that graphically displays various types of information managed in direct or indirect association with corporate issues and analysis results thereof. On this display screen, the analysis results can be displayed on a dashboard for each type. For example, the information processing system S can also generate and display, as the analysis result, information such as who has made proposals and how much, who has commented at the meeting and how much, how long it takes until a resolution is made on a certain issue, how many agenda items have been proposed this month, and how much time has been spent in the meeting.

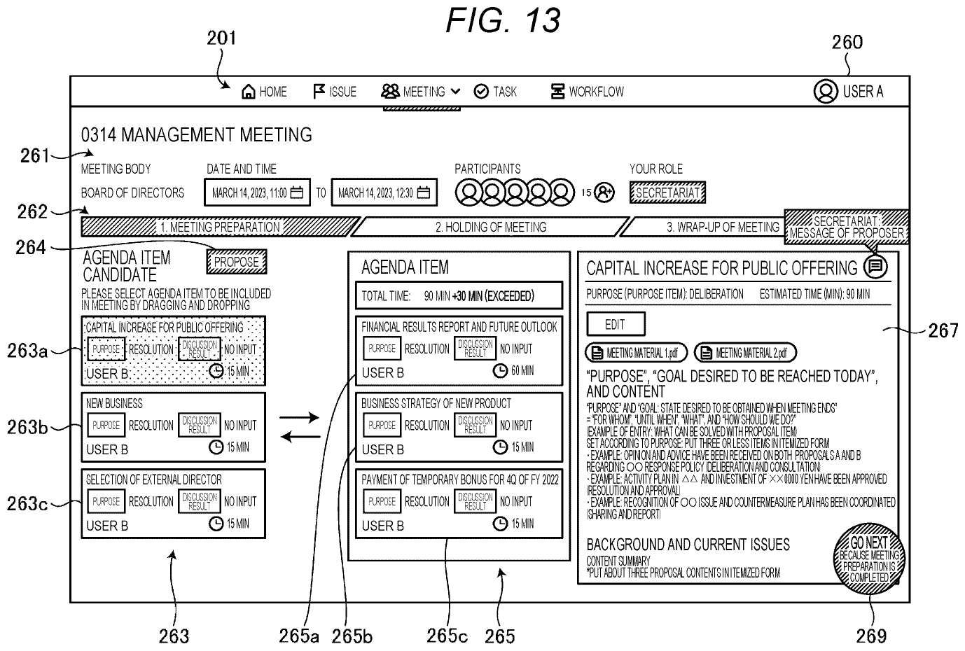

FIG. 13 is a figure illustrating an example of a display screen 260 displayed on the display device 30 of the terminal device T in the corporate issue management processing according to the embodiment.

The display screen 260 can function as, for example, a meeting preparation screen for meeting preparation for setting the agenda item of the meeting. The display screen 260 may include a display area 261 for displaying meeting information of a target meeting. The display area 261 may include, for example, items such as a title of the meeting, meeting body serving as the decision-making body, date and time of the meeting, participants, and role of the user P accessing from the terminal device T at the meeting.

The display screen 260 may include a display 262 indicating a progress status in a series of flows regarding the meeting. On the display screen 260, the display 262 may indicate the stage of “1. Meeting preparation” of the series of flows such as “1. Meeting preparation,” “2. Holding of meeting,” and “3. Wrap-up of meeting.”

In addition, the display screen 260 may include a display area 263 for displaying the agenda items proposed for the meeting, that is, agenda item candidates. In the example in FIG. 13, the display area 263 may include agenda item candidates 263a to 263c. Each of the agenda item candidates 263a to 263c may include display of a title, purpose, discussion result, person in charge, and expected time for the agenda item. In addition, the display screen 260 may include display of an operation button 264 reading “Propose” for instructing proposal of the agenda item for the meeting. The agenda item registered in association with the meeting by operating the operation button 264 is displayed in the display area 263 as the agenda item candidate. Note that the information processing system S may display the agenda item on which a decision has not yet been made at the previous meeting as the agenda item candidate.

In addition, the display screen 260 may include a display area 265 for displaying the agenda item on which a resolution or the like is to be made at the meeting. In the example in FIG. 13, the display area 265 may include agenda items 265a to 265c. Each of the agenda items 265a to 265c may include display of a title, purpose, discussion result, person in charge, and expected time for the agenda item.

For example, the user can move a displayed portion of the agenda item candidates 263a to 263c to the display area 265 of the agenda items by an operation such as drag and drop. For example, the user can move a displayed portion of the agenda items 265a to 265c to the display area 263 of the agenda item candidates by an operation such as drag and drop.

In addition, the display area 265 of the agenda items may include display of the total time of the expected times of the agenda items 265a to 265c. In addition, the display screen 260 may include a display area 267 for displaying details of the agenda item or agenda item candidate selected from among the agenda item candidates 263a to 263c and the agenda items 265a to 265c.

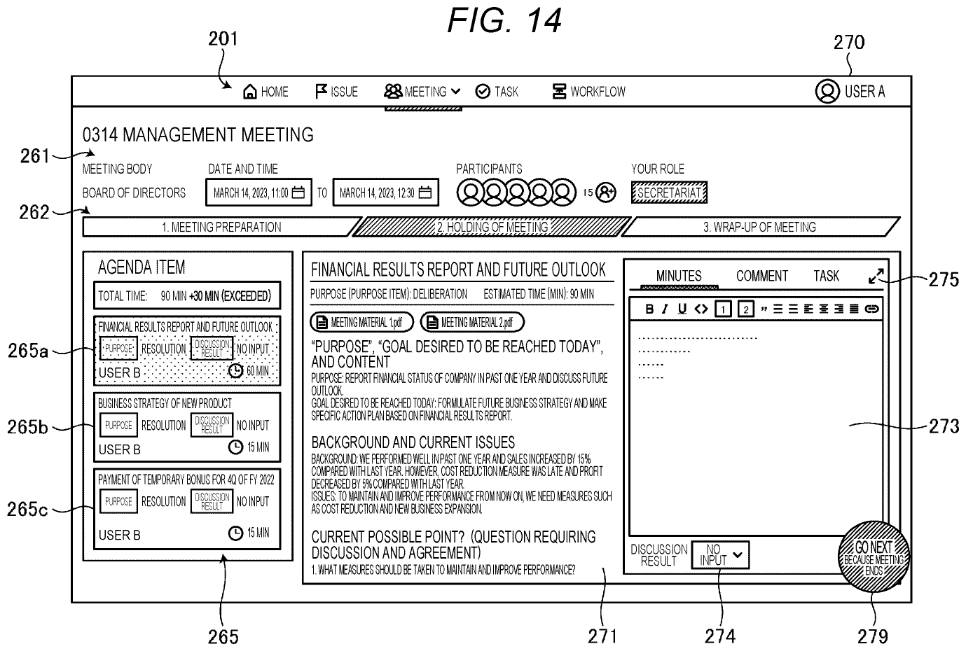

In addition, the display screen 260 may include display of an operation button 269 reading “Go next because meeting preparation is completed” for instructing completion of meeting preparation. For example, when the operation button 269 is operated, the output control unit 11b may display a display screen 270 in FIG. 14.

Note that a check list of preparation items required for a meeting operation process may be displayed on the display screen 260. That is, the information processing system S according to the embodiment may manage the preparation items in direct or indirect association with the corporate issues.

As described above, when making meeting preparation, the user P may select the agenda item on which decision-making or the like is to be performed at the meeting from among the agenda item candidates that have been proposed for the meeting, that is, managed in association with the meeting. In addition, the user P can select the agenda item on which decision-making or the like is to be performed at the meeting while checking the total expected time required to make a resolution on the agenda item or the content of each item.

FIG. 14 is a figure illustrating an example of a display screen 270 displayed on the display device 30 of the terminal device T in the corporate issue management processing according to the embodiment.

The display screen 270 can function as, for example, a meeting management screen for supporting the progress and operation of the meeting when the meeting is held. The display screen 270 may include the display area 261 for displaying the meeting information of the target meeting. In addition, on the display screen 270, the display 262 indicates the stage of “2. Holding of meeting” of the series of flows such as “1. Meeting preparation,” “2. Holding of meeting,” and “3. Wrap-up of meeting.”

The display screen 270 may include, for example, the display area 265 of the agenda items including the agenda items 265a to 265c set on the meeting preparation screen in FIG. 13. In addition, the display screen 270 may include a display area 271 for displaying details of the agenda item selected from among the agenda items 265a to 265c. Note that, in the display area 271, information on an agenda item on which a discussion has not been completed or a decision has not yet been made at the previous meeting may be displayed.

In addition, the display screen 270 may include an input field 273 for inputting, regarding the agenda item selected from among the items 265a to 265c, meeting minutes such as the resolution content or conclusion, a comment during the discussion such as a statement content of a member of the meeting, or the task for each agenda item generated at the meeting. Note that the minutes, comment, and task may be automatically input by voice recognition, or may be generated based on voice data obtained by recording the meeting. The content input to the input field 273 may be registered (managed) in the system in direct or indirect association with the meeting, the agenda item selected from among the items 265a to 265c, or the corporate issue with which the agenda item is associated.

In addition, the display screen 270 may include, for example, an input field 274 of a discussion result of the agenda item such as resolution or non-resolution. The input result to the input field 274 may be registered in the system in direct or indirect association with the meeting, the agenda item selected from among the items 265a to 265c, or the corporate issue with which the agenda item is associated, and, for example, may be displayed together with the meetings 225a to 225c in the display area 225 on the display screen 220 in FIG. 9.

In addition, the display screen 270 may include, for example, display of an icon 275 for instructing enlarged display or pop-up display of the input field 273 of the minutes, comment, and task.

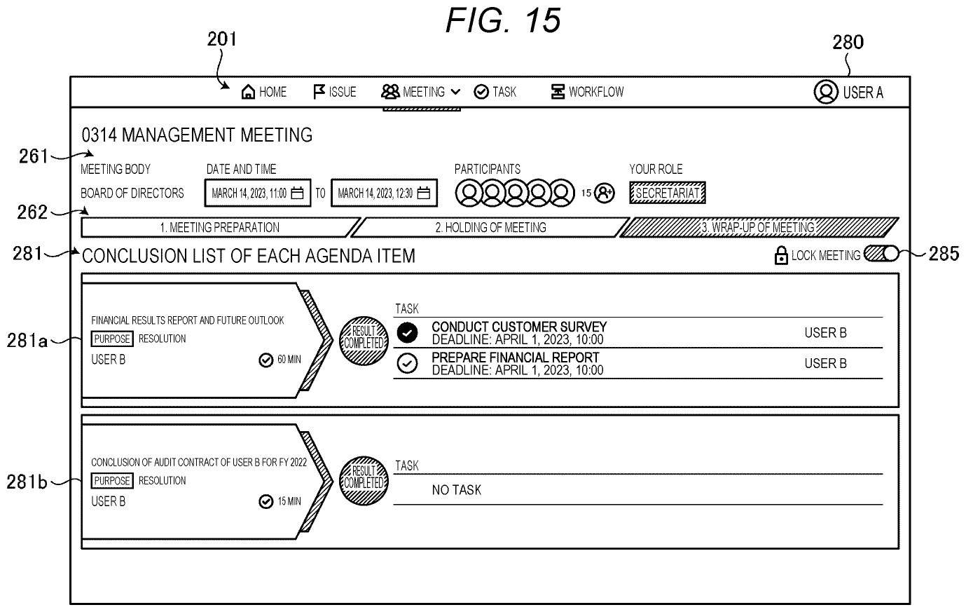

In addition, the display screen 270 may include display of an operation button 279 reading “Go next because meeting ends” for instructing completion of the meeting. For example, when the operation button 279 is operated, the output control unit 11b may display a display screen 280 in FIG. 15.

As described above, the information processing system S according to the embodiment can display the display screen 270 for receiving the input of the process and result of the discussion at the meeting and the generated task for each agenda item, and register the received input content in direct or indirect association with each agenda item.

FIG. 15 is a figure illustrating an example of a display screen 280 displayed on the display device 30 of the terminal device T in the corporate issue management processing according to the embodiment.

The display screen 280 may include a display area 281 for browsing a list of the meeting results across the plurality of agenda items. The display screen 280 may include the display area 261 for displaying the meeting information of the target meeting. In addition, on the display screen 280, the display 262 may indicate the stage of “3. Wrap-up of meeting” of the series of flows such as “1. Meeting preparation,” “2. Holding of meeting,” and “3. Wrap-up of meeting.”

In the example in FIG. 15, the display area 281 may include conclusions 281a and 281b of the agenda items. Each of the conclusions 281a and 281b of the agenda items may be information managed in direct or indirect association with the corporate issues, and include display of a title, purpose, person in charge, time required for the discussion on the agenda item, result, and task for the agenda item. In each of the conclusions 281a and 281b of the agenda items, the display of the task may include a title, deadline (due date), and person in charge of the task. In addition, the display of the task may include display of an icon indicating the executed state/unexecuted state of the task.

Note that the display screen can display allowing the user to check the status of the task of the issue. Such displaying may also be referred to as monitoring. In addition, display of a display area for the setting and an operation button for instructing display of the display screen may be included. The monitoring setting may be, for example, setting of a continuous report content, report timing, and report frequency, as well as a report destination and report content, sharing period, current status, and the like for intermediate report and final report after a resolution is made. In addition, in the monitoring setting, evaluation or the like of the resolution may be input. In addition, the information processing system S can manage the result of monitoring setting such as the report content in direct or indirect association with the corporate issue. As a result, it may be possible to refer to the result of a past monitoring setting during a new decision-making process regarding a related corporate issue.

In addition, the display screen 280 may include display of an operation icon 285 for instructing “Lock meeting” for the meeting. Here, to “lock meeting” may mean to restrict editing of the meeting information of the meeting and/or to shift to a mode of outputting open minutes in an uneditable format such as PDF. The open minutes can also be output with a content corresponding to browsing authority to be described later.

Note that the display screen 280 may display the agenda item on which the discussion has not been completed or a decision has not yet been made at the meeting, or may display an operation button for instructing movement of such an agenda item to the next meeting.

As described above, the information processing system S according to the embodiment can visualize and display, for each agenda item, the completion status regarding the task generated at the discussion on each agenda item when displaying the display screen 280 including a conclusion list of each agenda item at the meeting. As a result, the user P can visually grasp the task generated at the meeting and the completion status (topic-associated information) thereof.

In general, a series of discussions regarding the corporate issue may be conducted by a plurality of meeting bodies through a plurality of escalations. For this reason, when the discussion is managed for each meeting body, it may be necessary to check the proposal document and minutes on each agenda item in the progress of the corporate issue. Under such circumstances, with the information processing system S according to the embodiment, it may be possible to manage information such as the meeting, agenda item, and conclusion of the agenda item in direct or indirect association with the corporate issue, and thus, it may be possible to check the progress status and result of the series of discussions regarding the corporate issue by the plurality of meeting bodies at one time.

In addition, a relationship between the corporate issue and the workflow may not be limited to a one-to-one relationship. There may be a case where a plurality of corporate issues refer to and depend on each other. Under such circumstances, the information processing system S according to the embodiment can manage the reference/dependence relationship between a plurality of resolutions regarding the plurality of corporate issues by managing the related corporate issues in association with each other.

Note that the information processing system S according to the embodiment may be configured to collaborate with, for example, an external information processing system that generates information based on a trained model, specifically, an input in a natural language called prompt data or an input sentence and a large language model. Alternatively, the information processing system and the information processing system S according to the embodiment may be configured as one system. In addition, the information processing system may be one that is operated by an entity different from that of the information processing system S, that is, may be an external service provided by a third party.

The information processing system may include, for example, a machine learning model called a large language model (LLM). Examples of the machine learning model include bidirectional encoder representations from transformers (BERT) and a generative pre-trained transformer (GPT), particularly ChatGPT or GPT-4. The information processing system can implement functions thereof by using a hardware configuration, for example, a storage area, similar to that of the information processing system S or by causing a processor to execute a program stored in the storage area.

As an example, the external information processing system may have a configuration similar to that of a general computer similarly to the information processing device 10 of the information processing system S described with reference to FIG. 2, for example, and include a processor, a main storage device (memory), an auxiliary storage device (memory), a network interface, and a device interface as an example. The processor, the main storage device, the auxiliary storage device, the network interface, and the device interface of the external information processing system have hardware configurations similar to those of the processor 11, the main storage device 13, the auxiliary storage device 15, the network interface 17, and the device interface 18 of the information processing device 10, respectively, and the description thereof will be omitted. Note that the device interface in the information processing system may not be an essential configuration, and can be omitted as appropriate.

The generative model (for example, parameters defining the model) may be stored in a memory in the information processing system S, or may be stored in a memory in the external information processing system connected to be capable of communicating with the information processing system S. When the generative model stored in the external information processing system is used, the user can use a high-performance generative model while reducing the burden of cost such as training and maintenance of the model. In addition, the generative model may include a first generative model and a second generative model. When a plurality of models are used, for example, when the first generative model is used as a general-purpose large language model provided by an external vendor, which does not use user information for training, and the second generative model is trained or tuned according to preference or tendency based on the user information, it may be possible to generate more appropriate information for the user and to more appropriately manage the issue or information. Note that the second generative model in this case may generate information to be an input of the first model or adjust an input and an output of the first model.

The first generative model may be stored in the external information processing system, and the second generative model may be stored in the same storage device (memory) or different storage devices (memories) in the information processing system S connected to be capable of communicating with the external information processing system. Note that the second generative model may be one or more layers constituting a part of the first generative model, or may be a model separated from the first generative model.

In the information processing system S, the generative model can be variously utilized.

For example, the generative model may be used to generate information such as the corporate issue and the agenda item to be registered in the information processing system S. A sentence to be generated may be, for example, the wording such as an itemized description, a phrase, a subtitle, or the like. Note that a format defined for each meeting or each document may be prepared and input to the generative model together. For example, it may be possible to draft the agenda item according to the format by using prompt data “Generate the agenda item of a management meeting including these words in accordance with the format of the agenda item of the corporate issue.” This format can be set by the user or the information processing system S.

In addition, for example, the generative model can be used to generate and summarize the meeting minutes, proposal document on the corporate issue and agenda item, internal materials, and the like and to extract any information, for example, to extract any information such as the main agenda item and the schedule from the minutes. For example, the summary based on the minutes of each meeting may be displayed on the display screen displayed when the operation button 214 for instructing display of “Meeting list” on the display screen 210 in FIG. 8 is operated. In addition to the summary, information such as the background, purpose, check item, and determination item may be extracted and displayed.

In addition, for example, it may be possible to generate a document (for example, some highly confidential agenda item or other items may be deleted or replaced with the wording indicating that it cannot be browsed) having a different level of detail depending on browsing authority or the like regarding certain content. This document can be output, for example, as open minutes. Note that the setting of the browsing authority may be performed using, for example, regulations of authority registered in advance for each user, department, or meeting body to which the user or department belongs. As the regulations, authority regulations or an extension of the regulation may be managed in the information processing system S as the workflow. Note that the browsing authority may be settable for each issue, meeting, or agenda item.

In addition, an outline of the agenda item and a summary of the conclusion can be generated. For example, a summary of each of the meetings 225a to 225c may be displayed on the display screen 220 in FIG. 9. In addition, for example, on the display screen 280 in FIG. 15, a summary of the conclusions 281a and 281b of each agenda item may be displayed, or the extracted information such as the background, purpose, check item, and determination item may be displayed. In addition, the action included in the minutes may be extracted and automatically changed into a task and displayed as a task of the conclusions 281a and 281b on each agenda item on the display screen 280 in FIG. 15.

In addition, it may be possible to integrate discussions over a plurality of meetings and proposal items and generate a summary or abstract of a process. For example, on the display screen 220 in FIG. 9, the discussions over the meetings 225a to 225c up to the present may be integrated and displayed as the summary of the internal document.

In addition, it may be possible to extract a portion considered to be important or a portion desired to be noted using the generative model, and display such a point to be emphasized by highlighting or the like. For example, it may be possible to extract necessary information such as background, conclusion, check item, determination item, pointed-out item, action associated with task, amount of money, and schedule from the minutes or the summary of the minutes by the large language model, and further apply highlight display in different colors or displays according to the type of the information.

In addition, for example, the generative model may be used to search and output information necessary for the management of issues or information. The output may be, for example, generation of an answer or a draft answer to a question based on information obtained by searching internal documents (for example, business plan, financial plan, etc., company regulation, and information on a transaction party) including materials used for presentation at meetings and content and grounds related to the agenda item. The question may be related to a content that the user desires to check when proposing the agenda item, and the draft answer may be one to a question included in the agenda item.

In addition, for example, the generative model may be used to answer an inquiry about information regarding the agenda item, law, rule, guideline, company regulation, format, manual, and the like. The above may be output and displayed using, for example, prompt data for displaying information on an internal approval request route necessary for proposing the agenda item and information on laws that should be complied with or are considered to have a risk in relation to the agenda item and resolution content.

In the search based on the internal document and the answer output, for example, first, prompt data including a command to output an appropriate search query (for example, a keyword, text embedding, SQL, etc.) for obtaining information to answer the user's question or inquiry may be generated for the large language model. Then, the prompt data may be input to the large language model, and the obtained search query may be used to search the Internet, an information processing system, a database owned by the user, and the like. After a document including information necessary for the answer to the question may be identified by the search, information in the document and an instruction statement are input to the large language model or a proofreading program such that the information has an appropriate answer form, and the answer to the user's question or inquiry can be obtained as the output. The proofreading program may be appropriately stored in an internal memory of the information processing system S or the external information processing system if necessary.

Note that it may be preferable to prepare prompt data for a typical question or inquiry as a template. As a result, the user may not need to input the entire text of the prompt data. Examples of the inquiry may include proposal, survey, summarization, proofreading, and display of related rules. When the prompt data including a command statement that can execute an inquiry is created in advance in association with a button or a drop-down menu with content of the inquiry, the user can easily make the inquiry by performing selection or the like.

As for the input and output of the generative model, the user may perform the input into a window and the output may be displayed in the window, or an interactive type, such as a chatbot, may be adopted.

The information processing system S may be capable of performing management, such as display and monitoring, of a task other than the task for management and the meeting agenda item, similarly to the agenda item and the like. For example, progress confirmation and monitoring may also be performed on a task that has been broken down to implement a resolution item at the meetings but is not used as the agenda item of the meeting to be managed by the information processing system S.

Note that the user P may have different access rights to the information processing system S. The access right may be provided for each individual, or may be set for each group such as the department, decision-making body, or secretariat to which the user P belongs. In addition, the access right may be set based on information of a responsible department or the like (topic-associated information) set for the corporate issue (topic). For example, it may be conceivable that a user P who is a section manager has authority to browse, write, and edit all pieces of data related to the section manager meeting to which the user P belongs, has no access right to data regarding management meetings, and cannot browse the data, but has authority to browse and comment on data of a management meeting related to the corporate issue for which a department to which the user P belongs is set as a responsible department. In addition, the access right may be set for each corporate issue. In addition, in the case of a written resolution, the setting of making a decision for the user may be invalidated when the user is a related party and does not have the authority to make a decision.

Note that the information processing system S can display information necessary for corporate issue management in order to set the decision-making body corresponding to the agenda item. For example, information indicating a predetermined rule such as a law, rule, guideline, company regulation, and manual to be considered for selecting the decision-making body may be displayed. As a result, it is possible to easily manage the issue or information.

The information processing device 10 according to the embodiment includes at least one processor 11. The processor 11 implements the registration management unit 11a, the output control unit 11b, and the storage unit 11c. The processor 11 registers, in association with an issue including at least one agenda item, the at least one agenda item and at least one meeting held by at least one body of the organization to take an action on the at least one agenda item. The processor 11 outputs display information that displays, for each of the at least one agenda item, information based on a predetermined rule including information indicating the schedule or expectation of the future meeting to take an action on the agenda item.

In addition, the corporate issue management method according to the present embodiment may include registering, in association with an issue including at least one agenda item, the at least one agenda item and at least one meeting held by at least one body of the organization to take an action on the at least one agenda item. In addition, the corporate issue management method according to the present embodiment may include outputting display information that displays, for each of the at least one agenda item, the information based on the predetermined rule including the information indicating the schedule or expectation of the future meeting to take an action on the agenda item.

In addition, a non-transitory computer-readable medium according to the present embodiment may store instructions that, when executed by a computer, cause the computer to register, in association with an issue including at least one agenda item, the at least one agenda item and at least one meeting held by at least one body of the organization to take an action on the at least one agenda item. In addition, the instructions may cause the computer to output display information that displays, for each of the at least one agenda item, the information based on the predetermined rule including the information indicating the schedule or expectation of the future meeting to take an action on the agenda item.

According to these configurations, by managing the meeting based on the predetermined rule in association with the issue (topic) such as the corporate issue, that is, in direct or indirect association, it may be possible to present a future schedule or expectation regarding the meeting related to the user P accessing from the terminal device T. As a result, the user P can easily grasp for which meeting the user P should make a proposal next. That is, according to the above configuration, smooth operation of the meeting may be achieved. Therefore, with the technique according to the embodiment, it may be possible to support management of issues or information in the organization.

In addition, in the above configuration, information indicating the schedule or expectation of the future meeting may be generated based on the proposal route (workflow) for the agenda item registered in advance for each of at least one of the body, issue, and agenda item type. According to the above configuration, it may be possible to present to the user P the meetings scheduled or expected to be held in accordance with the predetermined rule such as the workflow registered in advance. As a result, the user P can appropriately propose the corporate issue (topic) and the agenda item, and smoothly operate the meeting.

In addition, in the above configuration, the display information that displays, for each of at least one agenda item, the information based on the predetermined rule may include information indicating a history of the action by at least one body together with the information indicating the schedule or expectation of the future meeting. According to this configuration, regarding the meeting related to the user P accessing from the terminal device T, it may be possible to present the past discussion and resolution result to the user P in addition to or instead of the future schedule or expectation. As a result, the user P can check at a glance the process of the discussion at the meeting and the current state of each agenda item. In addition, the user P can easily perform monitoring after the resolution, such as confirmation of the resolution content.

In addition, in the above configuration, at least one body that takes an action on the issue may be a meeting body. According to this configuration, it may be possible to present the future schedule and expectation regarding the meeting at which decision-making and information sharing are performed by the meeting body such as the board of directors, management meeting, operating officer meeting, business division meeting, general manager meeting, and section manager meeting, which are related to the user P accessing from the terminal device T.

Note that “determining whether it is A” in the above-described embodiment may be “determining that it is A”, “determining that it is not A”, or “determining whether or not it is A.”

Note that the program executed by each device of the information processing system S of the present embodiment may be provided by being recorded in a non-transitory computer-readable recording medium such as a CD-ROM, a flexible disk (FD), a CD-R, and a digital versatile disk (DVD) as a file in an installable format or an executable format. In addition, the program may be provided by being incorporated in a ROM or the like in advance.

Furthermore, the program may be stored on a computer connected to a network such as the Internet and provided by being downloaded via the network. In addition, the program may be provided or distributed via a network such as the Internet.

According to at least one embodiment described above, it is possible to support management of issues or information in the organization.

Although the embodiment and modifications of the present invention have been described, the embodiment and modifications are presented as examples, and are not intended to limit the scope of the invention. The novel embodiment and modifications can be implemented in various other forms, and various omissions, substitutions, and changes can be made without departing from the gist of the invention. The embodiment and the modifications thereof are included in the scope and gist of the invention, and are included in the invention described in the claims and the equivalent scope thereof.

What is claimed is:

1. An information processing device comprising:
at least one processor configured to:
register, in association with an issue including at least one agenda item, the at least one agenda item and at least one meeting held by at least one body of an organization to take an action on the at least one agenda item; and
output display information that displays, for each of the at least one agenda item, information based on a predetermined rule including information indicating a schedule or expectation of a future meeting to take an action on the agenda item.

2. The information processing device according to claim 1, wherein
the at least one processor is further configured to generate information indicating a schedule or expectation of the future meeting based on a proposal route for the agenda item registered in advance for each of at least one of the at least one body, the issue, and a type of the agenda item.

3. The information processing device according to claim 1, wherein
the at least one processor is further configured to output the display information that displays, for each of the at least one agenda item, the information based on the predetermined rule that includes information indicating a history of an action by the at least one body together with the information indicating the schedule or expectation of the future meeting.

4. The information processing device according to claim 1, wherein
the at least one body that takes an action on the issue is a meeting body.

5. A computer-implemented information processing method performed by one or more processors, the method comprising:
registering, in association with an issue including at least one agenda item, the at least one agenda item and at least one meeting held by at least one body of an organization to take an action on the at least one agenda item; and
outputting display information that displays, for each of the at least one agenda item, information based on a predetermined rule including information indicating a schedule or expectation of a future meeting to take an action on the agenda item.

6. A non-transitory computer-readable medium storing instructions that, when executed by one or more processors, cause the one or more processors to perform operations comprising:
registering, in association with an issue including at least one agenda item, the at least one agenda item and at least one meeting held by at least one body of an organization to take an action on the at least one agenda item; and
outputting display information that displays, for each of the at least one agenda item, information based on a predetermined rule including information indicating a schedule or expectation of a future meeting to take an action on the agenda item.
